(19) United States
(12) Patent Application Publication
(10) Pub. No.: US 2019/0067831 A1
(43) Pub. Date: Feb. 28, 2019

(54) STRIPLINE FEED STRUCTURE FOR SUPERLUMINAL ANTENNA ARRAY

(71) Applicants: COMMSCOPE, INC. OF NORTH CAROLINA, Hickory, NC (US); LOS ALAMOS NATIONAL SECURITY, LLC, Los Alamos, NM (US); OXBRIDGE PULSAR SOURCES LIMITED, Cambridge (GB)

(72) Inventors: Chris Hills, Fife (GB); Frank Krawczyk, White Rock, NM (US); Arzhang ARDAVAN, Oxford (GB); John SINGLETON, Los Alamos, NM (US); Andrea Caroline SCHMIDT, Los Alamos, NM (US)

(21) Appl. No.: 15/770,701

(22) PCT Filed: Oct. 26, 2016
(86) PCT No.: PCT/US16/58857

§ 371 Date: Apr. 24, 2018

Related U.S. Application Data
(60) Provisional application No. 62/246,369, filed on Oct. 26, 2015.

(51) Int. Cl. H01Q 21/00; H01Q 9/04; H01Q 13/22

(52) U.S. Cl. CPC H01Q 21/0075; H01Q 13/22; H01Q 9/0485

(57) ABSTRACT

A superluminal antenna element having a transmission line feed, and an array comprising a plurality of such antenna elements, is presented. In one example, the antenna element includes a dielectric base portion having a cutout area, a mode transition element coupled to the cutout, a stripline transmission line connected to the mode transition, and a dielectric radiator element disposed within the cutout. The cutout of the dielectric base portion has first and second pluralities of steps arranged in opposing pairs. The mode transition element is located below and coupled to the cutout area of the dielectric base portion. The dielectric radiator element is mounted within the cutout area in an opposing pair of steps. Imposing a time-varying signal on the dielectric radiator element by way of the transmission line, mode transition element, and stepped cutout induces a polarization current in the dielectric radiator element.

### STATEMENT REGARDING FEDERAL RIGHTS

This invention was made in part with government support under Contract No. DE-AC52-06NA25396 awarded to Los Alamos National Security, LLC (LANS) by the U.S. Department of Energy and made in part under CRADA number LA11C10646 between CommScope, Inc. of North Carolina and LANS. The government has certain rights in the invention.

### FIELD OF THE INVENTION

The present application relates to antennas, and, more particularly, to radiating dielectric elements that may be used in an antenna employing constant-speed or accelerated superluminal polarization currents and in small form-factor standard antennas based on polarization currents moving at constant superluminal speeds.

### BACKGROUND

Various designs for superluminal (faster than light in vacuo) radiating elements and arrays have been proposed. See, for example, U.S. Pat. Pub. No. 2013/0201073, which is incorporated by reference. Briefly, while matter or energy themselves cannot exceed the speed of light, an array of dielectric radiating elements may be excited in a sequence such that a polarization-current distribution (i.e., wave, chirp, or pulse) moves superluminally. Such a superluminally moving polarization-current distribution emits radiation; superluminal emission technology can be applied in a number of areas including radar, directed energy, communications applications, and ground-based astrophysics experiments.

It is desirable to build such a system using a modular approach with identical dielectric radiator elements closely spaced along a line or along a curve designed to give a desired, quasi-continuous trajectory in the whole volume of the dielectric for the polarization current. Previously designed modular antenna elements had a coaxial cable connected to each antenna element. For each antenna element, the inner conductor of the coaxial cable was connected to the electrode on one side of the dielectric radiator element and the outer conductor (ground) to an electrode on the other side of the dielectric radiator element. The application of a voltage signal to such a connection establishes an electric field across the dielectric radiator element and hence creates the polarization. The connection to ground is straightforward due to the accessibility of the outer conductor. However, the inner conductor requires careful shaping to establish a smooth change in impedance. Moreover, the relative height of the outer conductor to the inner conductor must be replicated to a high precision for each antenna element. Given the manufacturing tolerances, small variations in the relative heights of the conductors may result in wide performance variations. In addition, a concentric conducting tube was provided around the coaxial cable to act as a quarter-wave stub. However, in the original embodiment it was found that the performance of the quarter-wave stub was susceptible to slight variations in manufacturing tolerance, leading to variations in performance from almost identical elements. This is undesirable for industrial antenna production. Besides the inherent complexity, the prior approach with the cable in the z-direction also precluded small form-factor implementation for commercial applications.

### SUMMARY

A superluminal antenna element having an improved transmission line feed structure, and an array comprising a plurality of such antenna elements, is disclosed herein. The antenna element includes a dielectric base portion having a cutout area, a mode transition element, such as a patch element coupled to the cutout, a transmission line, such as a stripline transmission line connected to the mode transition, and a dielectric radiator element disposed within the cutout.

The cutout of the dielectric base portion has a first plurality of steps and a second plurality of steps, the first and second pluralities of steps being arranged in opposing pairs. The direction between opposing pairs defines an x-direction. The mode transition element is located below and coupled to the cutout area of the dielectric base portion, and energy is transitioned from the stripline to the cavity of the cutout by the mode transition element. In one example, the transmission line is oriented parallel to the x-direction and positioned under the antenna element to form a compact construction. First and second conductive elements substantially cover the first and second pluralities of steps, respectively. The dielectric radiator element is mounted within the cutout area. The dielectric radiator element has first and second spaced ends mounted in a pair of opposing pair of steps. Imposing a time-varying signal on the dielectric radiator element by way of the transmission line, mode transition element, and stepped cutout induces a polarization current in the dielectric radiator element.

The transmission line may comprise a stripline transmission line. In such an example, the stripline transmission line may comprise a metallic trace disposed on a dielectric substrate and be located between two metallic ground planes. The mode transition element may comprise a patch element coupled to the cutout. The patch element may be grounded at one end to at least one of the metallic ground planes of the stripline. A first end of the stripline transmission line may tenninate at a coaxial connector and a second end of the stripline transmission line may terminate at the mode transition element.

The cutout area of the dielectric base portion may be plated with conductive material to form the first and second conductive elements. The dielectric base portion may comprise a glass epoxy laminate.

The dielectric radiator element may be formed from a low-loss-tangent dielectric. The dielectric radiating element may be mounted within an outermost pair of opposing steps. The polarization current in the dielectric radiator element has an electric field that has a strong directional component parallel to the x-direction, which is the direction parallel to the direction between the pairs of opposing steps.

A superluminal antenna array may comprise an array of such antenna elements. When excited in sequence, the polarization current flows through the dielectric radiating element or elements along a length of the array in the y-direction.

A superluminal antenna array may include a dielectric base portion having a cutout, the cutout having a first plurality of steps and a second plurality of steps, the first and second pluralities of steps arranged in opposing pairs; a plurality of mode transition elements, located below and coupled to the cutout area of the dielectric base portion; and a plurality of transmission line feed lines, each being connected to one of the plurality of mode transition elements. A first conductive element may substantially cover the first plurality of steps and a second conductive element may substantially cover the second plurality of steps.

A dielectric radiator element is mounted within the cutout area, the radiator element having first and second spaced ends mounted in an opposing pair of steps. Imposing a time-varying signal on the plurality of feed lines induces a polarization current in the dielectric radiator element.

The plurality of transmission lines comprises a plurality of stripline transmission lines. Each stripline transmission line comprises a metallic trace disposed on a dielectric and is located between two metallic ground planes, and wherein each mode transition element comprises a patch element.

The array may comprise individual antenna elements or larger blocks or groups of components. For example, the first and second conducting elements may be segmented into a plurality of pairs of first and second conducting elements, and each segmented pair of first and second conducting elements corresponds to one patch element and one transmission line feed. Alternatively, the first and second conducting elements comprise metallic plated elements that continue for a length of the antenna array. Additionally, the dielectric radiating element and/or base portion may extend for the length of the antenna array.

The superluminal antenna may have the plurality of transmission feed lines coupled to a plurality of amplifiers. Alternatively, the superluminal antenna may have the plurality of transmission feed lines are coupled to a passive feed network. The passive feed network may comprise a plurality of power dividers and a plurality of delay lines.

### BRIEF DESCRIPTION OF THE DRAWINGS

FIG. 1 illustrates a first example of a superluminal array composed of a plurality of antenna elements according to a first aspect of the invention.

FIG. 2 illustrates an example of another superluminal array composed having some components shared along the length of the array according to another aspect of the invention.

FIG. 3 illustrates a base portion of an antenna element according to another aspect of the present invention.

FIG. 4 illustrates a base portion of an antenna including a stripline transmission line assembly according to another aspect of the invention.

FIGS. 5a and 5b illustrate various details of stripline transmission line assemblies according to another aspect of the invention.

FIG. 6 illustrates an example of another superluminal array having some components shared along the length of the array according to another aspect of the invention.

FIG. 7 illustrates a passive feed network that may be used in combination with superluminal antenna arrays as described herein.

### DETAILED DESCRIPTION

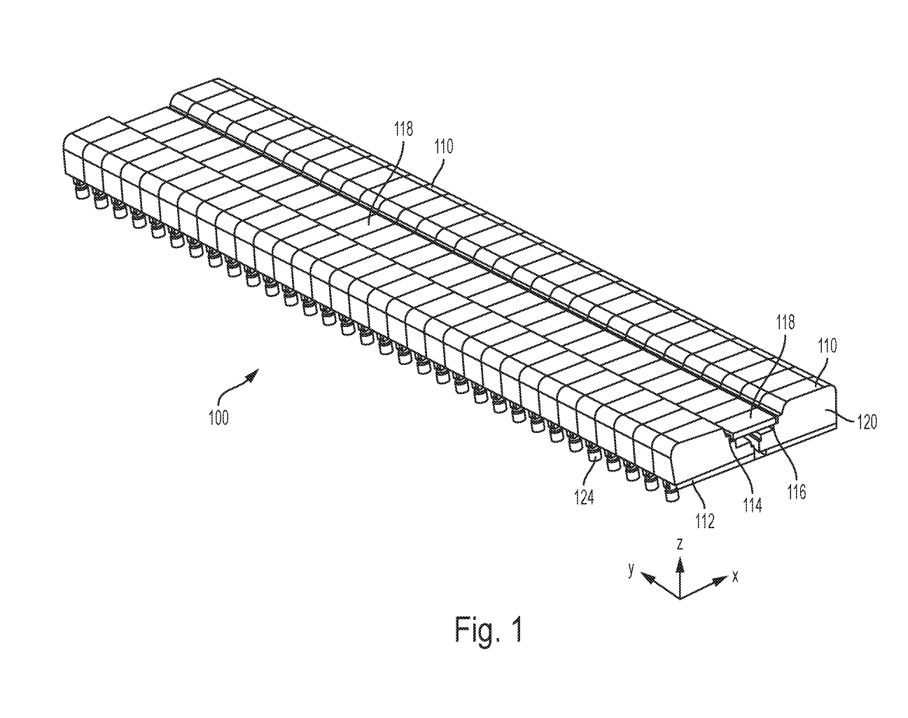

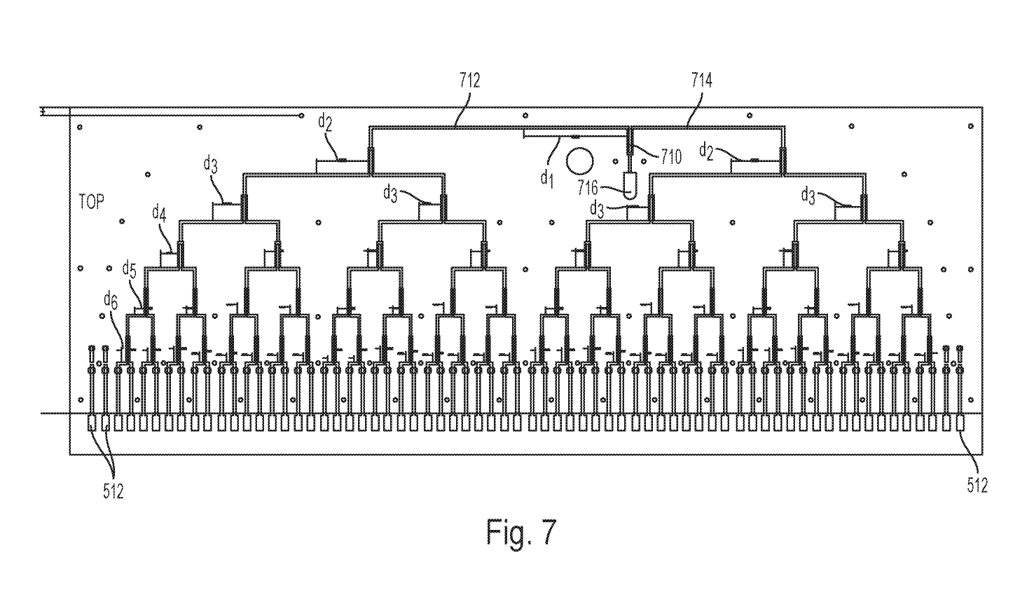

FIG. 1 shows a superluminal antenna 100 having a plurality of antenna elements 110. Each antenna element 110 has a stripline transmission line assembly 112 coupled thereto for delivering the desired voltage signal to the antenna element 110. Each antenna element 110 comprises a pair of electrodes 114, 116, placed on either side of a dielectric radiator element 118. The electrodes are supported on base portion 120, which may comprise two portions. Individual amplifiers (not shown) are coupled to the antenna elements 110 via the stripline feed assemblies 112 and can be used to control the polarization currents by applying voltages to the electrodes 114, 116 at desired time intervals or phases. Alternatively, the stripline feed assemblies 112 may be connected to a passive feed network of splitters and delay lines that provides signals with the correct phases, or time intervals, and amplitudes. FIG. 7 shows the implementation of a constant speed (non-accelerated), passive feed-network. By selecting different delay lengths for d1−d5 in each divider, acceleration schemes in the excitation profile may also be implemented. A single amplifier might be used to drive the latter passive feed network.

The implementation in FIG. 1 shows a SMA connector 124 to stripline transition for one possible interface to amplifiers or passive feed network. Nevertheless, the striplines could interface directly to a passive feed network on the same circuit board, or one close by, for example directly under the antenna assembly.

The application of voltage across a pair of electrodes creates a polarized region in the dielectric radiator elements 118 between the electrodes 114, 116, which can be moved by switching voltages between the electrodes on and off, or by applying oscillatory voltages with appropriate phase difference between radiator elements. Superluminal speeds can readily be achieved using switching speeds or oscillatory voltages in the MHz-GHz frequency range. The dielectric radiator element 118 between each pair of electrodes 114, 116 contains the polarization current that emits the desired radio-frequency (RF) electromagnetic waves, and thus functions as the radiating medium of each radiator element.

The individual antenna elements 110 allow for a modular approach that is easier to manufacture than previous designs. Superluminal antennas can be made by arrangement of individual antenna elements 110 in different ways. For example, while a straight line array is illustrated in FIG. 1, a circular configuration, a curved line or sinusoidal forms may also be used in combination with the disclosed transmission line feed structures.

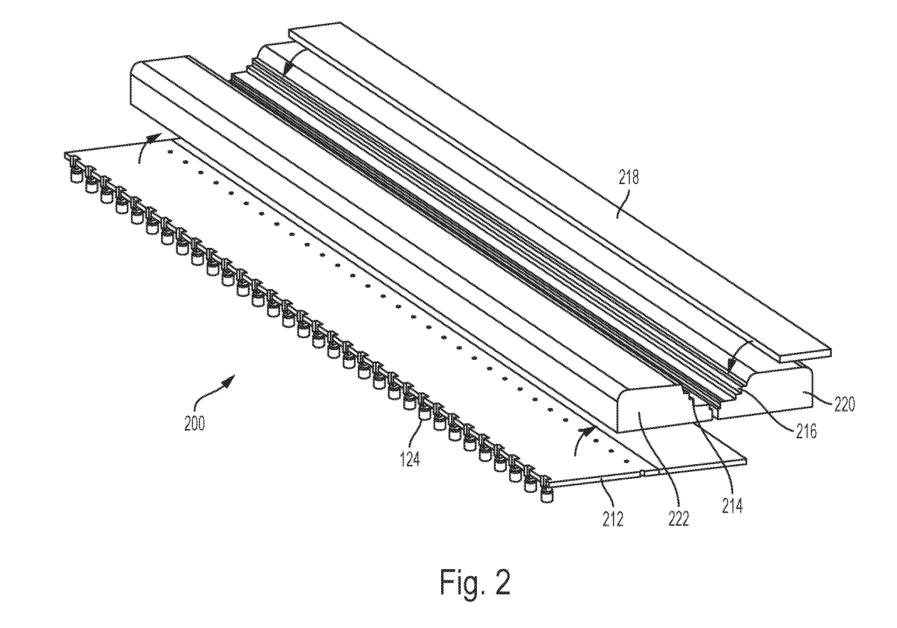

Though desirable in many applications, a modular approach is not necessary with this new design. Referring to FIG. 2, a superluminal antenna 200 comprises base portions 220, 222, stripline transmission line assembly 212 electrodes 214, 216 and dielectric radiator element 218. The example illustrated in FIG. 2 includes a plurality of SMA connectors 124. These may be driven sequentially to induce a polarization current in dielectric radiator element 218 and to move the displacement current along the length of dielectric radiator element 218. However, the non-modular approach of FIG. 2 may also be combined with the passive feed network of FIG. 7 to induce and drive a displacement current in dielectric radiator element 218. Additionally, a superluminal antenna according to the present invention may comprise groups of larger radiator structures combined together.

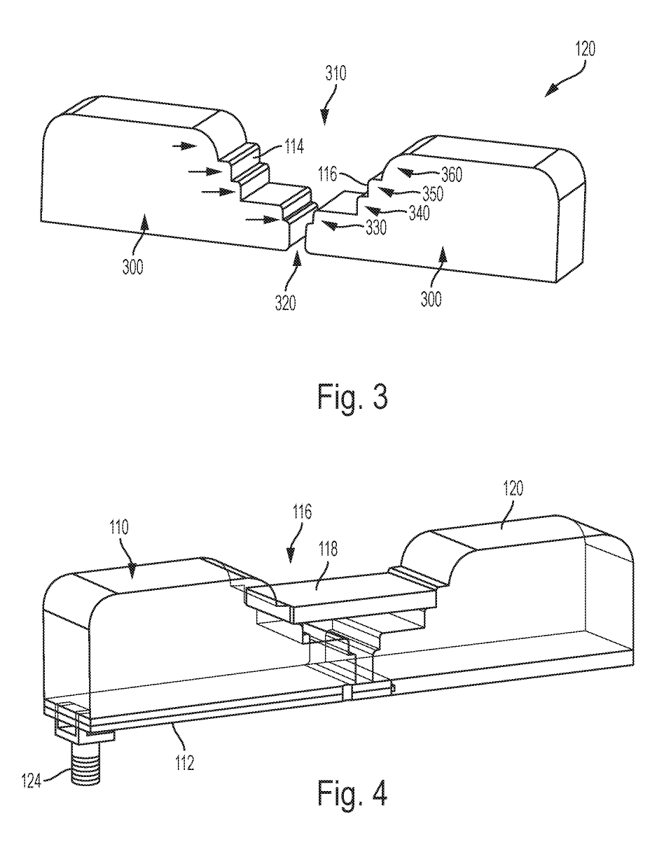

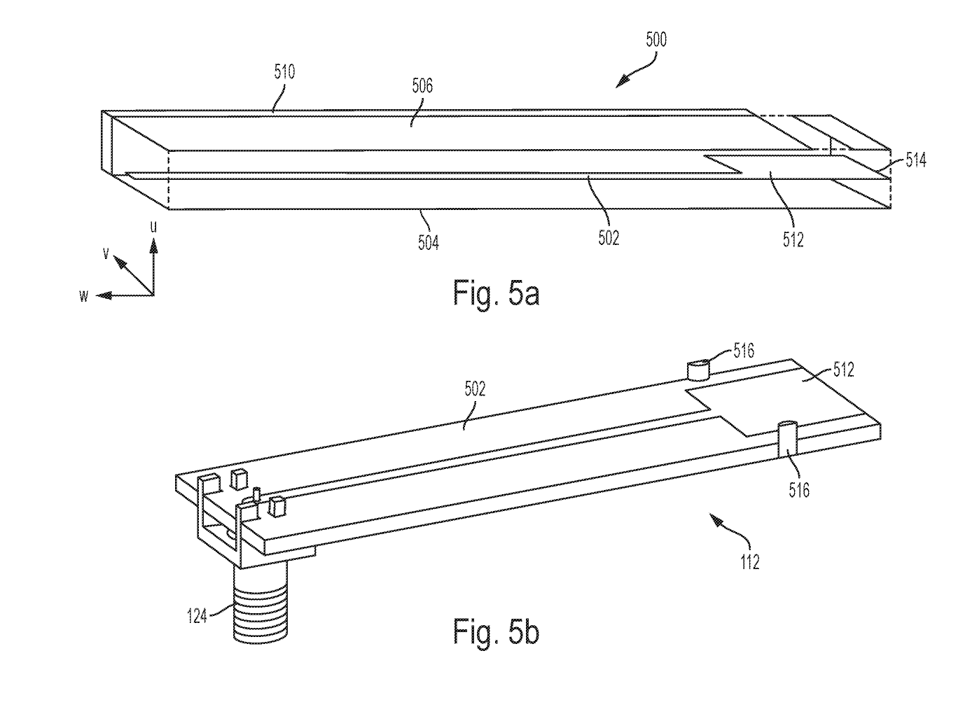

FIG. 3 shows a base portion 300 of an antenna element 110. The base portion 300 is generally a dielectric housing material having a cutout area 310 and a stripline RF feed (FIGS. 4, 5a, 5b). The dielectric housing material may be formed from a wide variety of dielectrics, such as glass epoxy laminates (e.g., G10, circuit board material). Example permittivity values are between 4 and 5, but other permittivity values can be used. The base portion in FIG. 3 is shown as rectangular shaped, but other shapes (e.g. wedges) can be used to form a curved or circular array. The cutout area 310 has a main section 320 into which the stripline couples, and a series of opposing steps 330, 340, 350, the outer pair of which, 350, is for mounting a dielectric radiator element.

The cut-out with the larger radius (360) is for guiding the radiation field. The cut-outs and surfaces exposed to the RF-fields are copper-plated to form electrodes 114, 116. In an array of antenna elements, a gap may be provided between the copper plating of adjacent elements. The arrangement shown in FIG. 1 does not have such a gap. The cut-out areas 310 are stepped to provide stepped impedance transitions which are optimized for minimum reflection of RF fields back into the strip-line. The cutout area 310 can be a wide variety of shapes, depending on the particular application and frequencies being used.

The dielectric radiator element may be made from any low-loss-tangent dielectric with a reasonably high dielectric constant, such as high purity alumina, which has εᵣ=10.

FIG. 4 illustrates another example of a base portion 300 of an antenna element 110; some parts of the structure are shown shaded. FIG. 4 also illustrates a stripline transmission line assembly 112 as it is located with respect to the base portion 310 of the antenna element 110. The stripline transmission line assembly is oriented perpendicular to the orientation of the cutout area and parallel to a direction between opposing steps, allowing for compact dimensions of construction relative to coaxial cable-fed antenna elements.

FIG. 5a shows an overview of a stripline transmission line assembly 112. The antenna element 110 or antenna 200 may be fed by a strip-line 502 with its impedance matched to the relevant source impedance (here implemented at 50Ω). Below the cut-out area 310, the strip-line is terminated by a mode conversion element, such as patch 514. Patch 514 is optimized to minimize reflections and orient the electric field emanating from the patch to be parallel to a direction between opposing steps and transverse to a longitudinal direction of the array. The dimensions here are optimized for operation in a frequency range from 1.9 to 2.6 GHz. The concept is, however, not limited to this frequency range.

The stripline RF feed 500 illustrated in FIG. 5a may comprise a metallic strip 502 implemented as a trace on a dielectric, disposed between two metallic ground planes 504, 506. Preferably, the stripline is isolated from a neighboring stripline by additional metallic walls 510, such that the stripline is disposed within a rectangular cross-section. The stripline may terminate in a rectangular patch element 512. The patch element may be shorted to ground shield 514 of the stripline. The metallic ground planes and/or walls may comprise copper-plated dielectric. The advantage of this approach is the excellent decoupling between striplines; however this approach is not compatible with the monolithic fabrication approach.

The solution FIG. 5b shows an implementation of a stripline transmission line assembly 112 without the metallic walls 510. Electric separation of the striplines is achieved by pins 516 in the separation plane between neighboring individual radiator elements.

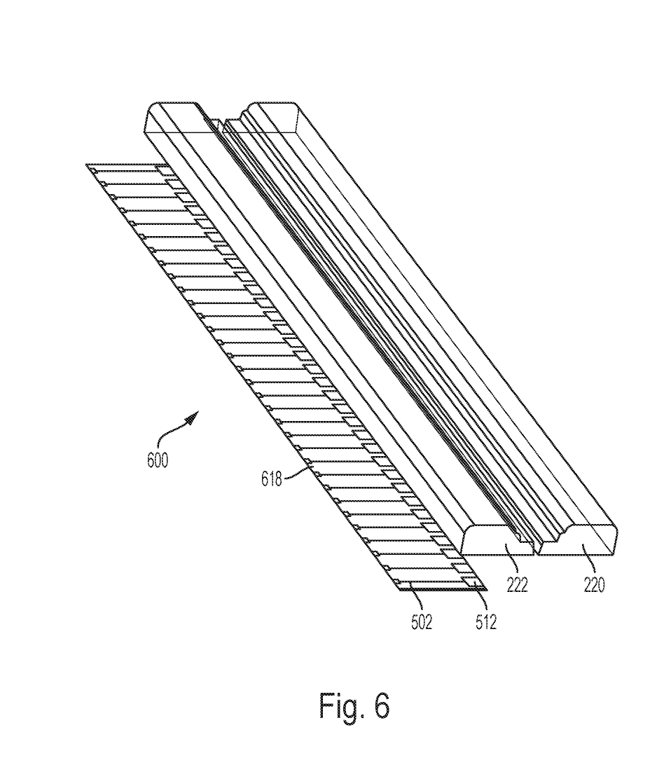

FIG. 6 illustrates a combination of antenna base portions 220, 222 and feed structure of FIG. 5, wherein a plurality of stripline transmission lines 510 are implemented on a circuit board 618.

The figures present an optimized solution for a 50Ω strip-line. The inventive concept, however, is more generic and extends to drives of arbitrary impedance and related optimized patch antennas and cut-outs. In another example the stripline drivers are fabricated separately from the antenna elements and then attached.

The drive concept in FIG. 4 is an example configuration where an individual element can be connected to a source via an SMA connection. The SMA connection connects to the stripline and ground planes. However, the design is not limited to this implementation. For example, in FIG. 7, direct stripline connections may be provided between an array of antenna elements 110 and a source comprising a complex stripline configuration 700 consisting of power splitters 710 and delay lines 712, 714 that provide a constant or increasing phase shift between neighboring elements that is required for a superluminal propagation of the polarization currents. The delay imparted by delay line 712 is larger than delay line 714 by an amount dl. Delay line length differences d1−d5 impart a constant phase shift. An input 716 is provided. Such an assembly is referred to as a passive feed network above, and could be situated on the same circuit board as the antenna feeds, or an adjacent circuit board, for example directly under the array of elements.

Unique properties of this concept include the transfer of a stripline mode into a linear polarization field and current. The mode transfer occurs where the patch 512 or other mode conversion element couples radio frequency energy to the cutout area 310. The concept implementation requires an arrangement (in linear or radial direction) of multiple elements like the one shown in FIG. 1. The elements are designed to create a strong x-component (i.e., the direction across opposing steps 350 of cutout 310) of polarization current throughout the volume of the dielectric, with a very small z-component (i.e., perpendicular to the face of the array). The y-direction component (i.e., parallel to a longitudinal axis of the array) of the electric field should be well defined and not vary rapidly with distance along a length of the array. The polarization current fills the array of dielectric radiating elements, and propagates along and within them, generating electromagnetic waves. This emission of electromagnetic waves from a true volume current differentiates an array according to the present invention from conventional phased arrays, which generate electromagnetic waves from discrete point, line, or surface sources.

An advantage of an array of such antenna elements is that they may be excited such that the polarization current has a phase velocity νₚₕ along the array faster than the speed of light c (at least in part of or some of the dielectric radiating elements). This phase velocity may be arranged to increase or decrease, yielding acceleration, which is important for focusing of the emitted radiation. Desired operation includes phase velocities larger than c everywhere in the dielectric (both in linear or circular arrangements), and a mode of operation where the phase velocity makes a transition from νₚₕ<c to νₚₕ>c in the tangential direction as the radius increases for a circular arrangement of elements. The optimization also includes a design with a bandwidth of at least 20% of the center frequency.

Strip-line or micro-strip-line antenna drives according to the present invention are superior for implementation of low-cost low-complexity drives with fixed or increasing phase advance from element to element. The strip-line directly feeds into the antenna element. Strip-lines are preferable to micro-strip-lines, as they are shielded and avoid cross-talk between neighboring feeds. This approach does not preclude an overall coaxial feed, but any conversion from coaxial to strip-line mode is removed from the antenna element itself. Implementation with striplines only, or with coax-to-stripline transitions in the x-direction (instead of the z-direction) also provides superior antennas with a uniquely flat form-factor.

The strip-line to cutout feed allows for a significant reduction of fabrication steps and handling of small elements. Any arrangement of radiator elements can be cut from one piece of G10 dielectric material, and then copper plated to form electrodes. The polarization dielectric can also be added as one single machined piece covering all antenna elements of an arrangement. Then the individual strip-line feeds can be added or one printed circuit board with all striplines of an arrangement can be added (FIG. 6), potentially as integral part of a printed circuit board that includes power splitters, delay lines (for the phase changes) and the connection to the RF-power source.

The design also includes the arrangement of individual elements (FIG. 1) to provide a polarization current topology with smoothly varying electric fields in the x- and y-directions. The fields in the neighboring dielectric radiating elements provide the right boundary conditions for each other. The transversely open configuration also provides the smooth transition of current amplitude from element to element in the y-direction.

In view of the many possible embodiments to which the principles of the disclosed invention may be applied, it should be recognized that the illustrated embodiments are only preferred examples of the invention and should not be taken as limiting the scope of the invention.

What is claimed is:

1. A superluminal antenna element, comprising:
a dielectric base portion having a cutout, the cutout having a first plurality of steps and a second plurality of steps, the first and second pluralities of steps arranged in opposing pairs, a direction between opposing pairs of steps defining an x-direction;
a mode transition element, located below and coupled to the cutout area of the dielectric base portion;
a transmission line feed line connected to the mode transition element and parallel to the x-direction;
a first conductive element substantially covering the first plurality of steps;
a second conductive element substantially covering the second plurality of steps;
a dielectric radiator element mounted within the cutout area, the radiator element having first and second spaced ends mounted in a pair of opposing pair of steps;
whereby imposing a time-varying signal on the dielectric radiator element by way of the transmission line, mode transition element, and stepped cutout induces a polarization current in the dielectric radiator element.

2. The superluminal antenna element of claim 1, wherein the transmission line comprises a stripline transmission line.

3. The superluminal antenna element of claim 2, wherein the stripline transmission line comprises a metallic trace disposed on a dielectric substrate and is located between two metallic ground planes.

4. The superluminal antenna element of claim 1, wherein the mode transition element comprises a patch element coupled to the cutout.

5. The superluminal antenna element of claim 1, wherein transmission line comprises a stripline transmission line disposed between two metallic ground planes, the mode transition element comprises a patch element, and the patch element is grounded at one end to at least one of the metallic ground planes.

6. The superluminal antenna element of claim 1, wherein the cutout area of the dielectric base portion is plated with conductive material to form the first and second conductive elements.

7. The superluminal antenna element of claim 1, wherein the dielectric radiator element is formed from a low-loss-tangent dielectric.

8. The superluminal antenna element of claim 1 wherein a first end of the stripline transmission line terminates at a coaxial connector and a second end of the stripline transmission line terminates at the mode transition element.

9. The antenna element of claim 1, wherein the dielectric radiating element is mounted within an outermost pair of opposing steps.

10. The antenna element of claim 1, wherein the polarization current in the dielectric radiator element has an electric field that has a strong directional component parallel to the x-direction.

11. A superluminal antenna array comprising an array of antenna elements as recited in claim 10.

12. The superluminal antenna array of claim 11, wherein a length of the antenna array defines a y-direction, and a y-direction component of the electric field does not vary rapidly over the length of the antenna array.

13. A superluminal antenna, comprising:
a dielectric base portion having a cutout, the cutout having a first plurality of steps and a second plurality of steps, the first and second pluralities of steps arranged in opposing pairs;
a plurality of mode transition elements, located below and coupled to the cutout area of the dielectric base portion;
a plurality of transmission line feed lines, each being connected to one of the plurality of mode transition elements;
a first conductive element substantially covering the first plurality of steps;
a second conductive element substantially covering the second plurality of steps;
a dielectric radiator element mounted within the cutout area, the radiator element having first and second spaced ends mounted in a pair of opposing pair of steps;
whereby imposing a time-varying signal on the plurality of feed lines induces a polarization current in the dielectric radiator element that propagates along a length of the array.

14. The superluminal antenna of claim 13, wherein the plurality of transmission lines comprises a plurality of stripline transmission lines.

15. The superluminal antenna of claim 14, wherein each stripline transmission line comprises a metallic trace disposed on a dielectric substrate and is located between two metallic ground planes, and wherein each mode transition element comprises a patch element.

16. The superluminal antenna of claim 13, wherein the first and second conducting elements are segmented into a plurality of pairs of first and second conducting elements, and each segmented pair of first and second conducting elements corresponds to one patch element and one transmission line feed.

17. The superluminal antenna of claim 13, wherein the antenna array has a length, and wherein the first and second conducting elements comprise metallic plated elements that continue for the length of the antenna array.

18. The superluminal antenna of claim 13, wherein the antenna array has a length, and wherein the dielectric radiating elements extends for the length of the antenna array.

19. The superluminal antenna of claim 13, wherein the plurality of transmission feed lines are coupled to a plurality of amplifiers.

20. The superluminal antenna of claim 13, wherein the plurality of transmission feed lines are coupled to a passive feed network.

21. The superluminal antenna of claim 20, wherein the passive feed network comprises a plurality of power dividers and a plurality of delay lines.

22. The superluminal antenna of claim 20, wherein the passive feed network is located under the antenna and transmission line feed lines.
